(19) United States
(12) Patent Application Publication
(10) Pub. No.: US 2026/0237150 A1
(43) Pub. Date: Aug. 13, 2026

(54) STORAGE MEDIUM, IMAGE PROCESSING METHOD, AND IMAGE PROCESSING SYSTEM

(71) Applicant: NINTENDO CO., LTD., Kyoto (JP)

(72) Inventors: Riki FUKUNARI, Kyoto (JP); Tomohiro NAKATANI, Kyoto (JP)

(21) Appl. No.: 19/311,962

(22) Filed: Aug. 27, 2025

(30) Foreign Application Priority Data
Feb. 7, 2025 (JP) 2025-019350

(51) Int. Cl. G06T 15/50; G06T 15/06

(52) U.S. Cl. CPC G06T 15/506; G06T 15/06; G06T 2210/21

(57) ABSTRACT

A virtual space is rendered. The brightness of a rendered scene is obtained. A first luminance correction value is determined in a first range and a second luminance correction value is determined in a second range, based on the brightness of the scene. For rendered pixels, based on the luminances of the pixels, luminance correction based on the first luminance correction value is performed on pixels satisfying a condition under which it is determined that a pixel is dark, and luminance correction based on the second luminance correction value is performed on pixels satisfying a condition under which it is determined that a pixel is bright.

### CROSS REFERENCE TO RELATED APPLICATION

This application claims priority to Japanese Patent Application No. 2025-019350, filed on Feb. 7, 2025, the entire contents of which are incorporated herein by reference.

### FIELD

The technology disclosed herein relates to storage media, image processing methods, and image processing systems that render a virtual space.

### BACKGROUND AND SUMMARY

There has conventionally been a game in which a racing game is played on a predetermined course, and different scenes in the racing game are rendered with different brightnesses.

For example, it may be difficult to render a scene with an appropriate brightness, depending on the brightness of the scene, in a game.

The present example discloses a storage medium, image processing method, and image processing system capable of performing brightness correction according to the brightness of a scene in various situations in a game or the like.

The present example may, for example, have the following features (1) to (14).
(1) An example configuration of a non-transitory computer-readable storage medium according to the present example is a non-transitory computer-readable storage medium having stored therein an image processing program that when executed, causes one or more processors of an information processing apparatus to execute operations comprising: rendering a virtual space; obtaining the brightness of a rendered scene; determining a first luminance correction value in a first range and a second luminance correction value in a second range based on the brightness of the scene; and for rendered pixels, based on the luminances of the pixels, performing luminance correction based on the first luminance correction value, on pixels satisfying a condition under which it is determined that a pixel is dark, and performing luminance correction based on the second luminance correction value, on pixels satisfying a condition under which it is determined that a pixel is bright.
With the configuration of (1), different types of luminance correction can be performed on pixels satisfying the condition under which it is determined that a pixel is dark and pixels satisfying the condition under which it is determined that a pixel is bright, based on the brightness of a rendered scene. For example, pixels satisfying the condition under which it is determined that a pixel is dark are subjected to luminance correction for increasing the brightness, and pixels satisfying the condition under which it is determined that a pixel is bright are subjected to luminance correction for reducing the brightness. As a result, a deterioration in the visibility of a game image due to washing-out or the like can be reduced while a deterioration in the visibility of a game image due to insufficient brightness or the like can be reduced.
(2) In the configuration of (1), the operations may further comprise: rendering the virtual space based on lighting settings related to virtual time periods of day that transition according to the passage of time.
With the configuration of (2), even when the lighting settings are changed due to transition of the virtual time periods of day, luminance correction based on the brightness of a scene can be performed.
(3) In the configuration of (2), the first range may be a range between a first correction minimum value and a first correction maximum value. The second range may be a range between a second correction minimum value and a second correction maximum value. The first correction minimum value, the first correction maximum value, the second correction minimum value, and the second correction maximum value may each be set in association with each of the virtual time periods of day.
With the configuration of (3), pixels satisfying the condition under which it is determined that a pixel is dark and pixels satisfying the condition under which it is determined that a pixel is bright can be subjected to luminance correction based on the virtual time periods of day that transition according to the passage of time.
(4) In the configuration of (3), a determination minimum value and a determination maximum value related to the brightness of the scene may be set in association with each of the virtual time periods of day. In this case, the operations may further comprise: when the brightness of the scene is lower than or equal to the determination minimum value, determining that the first luminance correction value is the first correction maximum value, and the second luminance correction value is the second correction maximum value; when the brightness of the scene is higher than or equal to the determination maximum value, determining that the first luminance correction value is the first correction minimum value, and the second luminance correction value is the second correction minimum value; and when the brightness of the scene is between the determination minimum value and the determination maximum value, determining that the first luminance correction value is a value between the first correction minimum value and the first correction maximum value, and the second luminance correction value is a value between the second correction minimum value and the second correction maximum value, by interpolation based on the brightness.
With the configuration of (4), a luminance correction value for performing luminance correction on pixels satisfying the condition under which it is determined that a pixel is dark and a luminance correction value for performing luminance correction on pixels satisfying the condition under which it is determined that a pixel is bright can be determined according to the brightness of a rendered scene.
(5) In the configuration of (3) or (4), the operations may further comprise: setting the second correction maximum value to a value smaller than the first correction maximum value, in association with a first time period of day of the virtual time periods of day; and setting the first correction minimum value and the second correction minimum value to the same value, and the first correction maximum value and the second correction maximum value to the same value, in association with a second time period of day of the virtual time periods of day.
With the configuration of (5), the time period of day for which it is desired that washing-out is inhibited, and the time period of day for which pixels satisfying the condition under which it is determined that a pixel is dark and pixels satisfying the condition under which it is determined that a pixel is bright are subjected to the same luminance correction, can be used separately.
(6) In the configuration of any one of (2) to (5), the condition under which it is determined that a pixel is dark may be that the luminance of the pixel is lower than a threshold set in association with the virtual time periods of day. The condition under which it is determined that a pixel is bright may be that the luminance of the pixel is higher than or equal to the threshold.
With the configuration of (6), pixels satisfying the condition under which it is determined that a pixel is dark, and pixels satisfying the condition under which it is determined that a pixel is bright, can be determined according to the virtual time periods of day.
(7) In the configuration of any one of (1) to (5), the condition under which it is determined that a pixel is dark may be that the luminance of the pixel is lower than a threshold. The condition under which it is determined that a pixel is bright may be that the luminance of the pixel is higher than or equal to the threshold.
With the configuration of (7), by setting a threshold, pixels satisfying the condition under which it is determined that a pixel is dark, and pixels satisfying the condition under which it is determined that a pixel is bright, can be easily determined.
(8) In the configuration of (6) or (7), the operations may further comprise: performing the luminance correction on a pixel whose luminance is lower than the threshold, by changing the luminance of the pixel by a first magnification factor depending on the first luminance correction value; and performing the luminance correction on a pixel whose luminance is higher than or equal to the threshold, by changing the luminance of the pixel by a second magnification factor that further approaches from the first magnification factor to a magnification factor depending on the second luminance correction value as the luminance increases from the threshold
With the configuration of (8), the luminance correction value can be continuously set.
(9) In the configuration of any one of (1) to (8), the operations may further comprise: obtaining the brightness of the rendered scene based on a light probe disposed in the virtual space.
With the configuration of (9), the brightnesses of various rendered scenes can be obtained.
(10) In the configuration of (9), the operations may further comprise: obtaining the brightnesses of a plurality of sampling points set in the scene, based on the light probes arranged around positions in the virtual space related to the plurality of sampling points, and obtaining the brightness of the scene based on the brightnesses of the plurality of sampling points.
With the configuration of (10), the brightness of a scene can be obtained using the brightnesses of a plurality of sampling point set in the virtual space.
(11) In the configuration of (10), the operations may further comprise: performing ray casting in a direction from a reference point in the virtual space, and setting the sampling point at, at least, a collision position of the ray casting with respect to an object in the virtual space, and one or more positions between the reference point and the collision position.
With the configuration of (11), the brightness of a scene in a region subjected to ray casting from the reference point can be obtained.
(12) In the configuration of (11), the reference point may be set based on a position of a gaze point of a virtual camera.
With the configuration of (12), the brightness of a scene can be obtained with reference to the gaze point of the virtual camera.
(13) In the configuration of (11) or (12), the operations may further comprise: performing the ray casting in one or more random directions for each rendering frame, and smoothing the brightness based on the sampling points due to the ray casting, and the brightness based on the sampling points due to the ray casting in a past frame, to obtain the brightness of the scene.
With the configuration of (13), ray casting is performed in a predetermined number of random directions for each rendering frame, and the brightness calculated for each rendering frame is smoothed. As a result, the brightness of a scene based on ray casting performed in all directions can be obtained.
(14) In the configuration of any one of (11) to (13), the operations may further comprise at least one of: giving a greater weight to the sampling point closer to the reference point, and obtaining the total brightness of the plurality of sampling points as the brightness of the scene; and setting more sampling points in regions closer to the reference point, between the reference point and the collision position caused by the ray casting.
With the configuration of (14), the brightness of a scene in which attention is paid to the brightness of a region closer to the reference point in the virtual space can be obtained.

In addition, the present example may be carried out in the forms of an image processing method and an image processing system.

According to the present example, different types of luminance correction can be performed on pixels satisfying the condition under which it is determined that a pixel is dark ζ pixels satisfying the condition under which it is determined that a pixel is bright, based on the brightness of a rendered scene.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example of a game system,

FIG. 2 is a block diagram showing a non-limiting example of an internal configuration of a main body apparatus 2,

FIG. 3 is a diagram showing a non-limiting example of an entire field in a virtual space,

FIG. 4 is a diagram showing a non-limiting example of an intra-base site course on which several laps are traveled around an intra-base site route CA1, as viewed from above in a virtual space,

FIG. 5 is a diagram showing a non-limiting example of an inter-base site course including an inter-base site route R3 as viewed from above in a virtual space,

FIG. 6 is a diagram showing a non-limiting example of a game image displayed during a racing game,

FIG. 7 is a diagram showing a non-limiting example of light probes 60 arranged in a virtual space,

FIG. 8 is a diagram showing a non-limiting example of ray casting that is performed in a predetermined direction from a gaze point in a virtual space,

FIG. 9 is a diagram showing a non-limiting example in which sampling points SP are set in a virtual space,

FIG. 10 is a diagram showing a non-limiting example of luminance correction value ranges prepared for virtual time periods of day,

FIG. 11 is a graph showing a non-limiting example of luminance correction values applied to the luminance of a rendered pixel,

FIG. 12 is a diagram showing a non-limiting example of luminance correction performed on dark-place pixels based on a first luminance correction value EVa, and luminance correction performed on light-place pixels based on the second luminance correction value EVb, for the game image of FIG. 6,

FIG. 13 is a diagram showing a non-limiting example of various data used in information processing in a game system 1,

FIG. 14 is a flowchart showing a non-limiting example of a flow of game processing executed by a game system 1, and

FIG. 15 is a subroutine showing a non-limiting example of a rendering process executed in step S5 of FIG. 14.

### DETAILED DESCRIPTION OF NON-LIMITING EXAMPLE EMBODIMENTS

### 1. Configuration of Game System

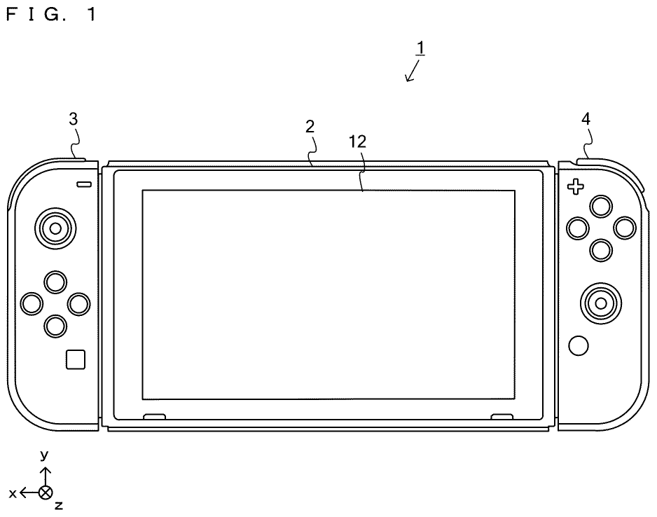

A game system according to the present example will be described below. FIG. 1 is a diagram showing an example of the game system. An example of the game system 1 of the present example includes a main body apparatus (information processing apparatus; functioning as the main body of a game apparatus in the present example) 2, and a left controller 3 and a right controller 4. The main body apparatus 2 executes various processes (e.g., a game process) in the game system 1. The left controller 3 and the right controller 4 include a plurality of buttons (the A-button, B-button, X-button, Y-button, L-button, R-button, and the like) and an analog stick as an example of an operation unit for the user's input.

The main body apparatus 2 is configured such that the left controller 3 and the right controller 4 are removably attached thereto. Specifically, the game system 1 can be used as a unified apparatus obtained by attaching the left controller 3 and the right controller 4 to the main body apparatus 2. Alternatively, the main body apparatus 2 and the left controller 3 and the right controller 4 can be used separately. It should be noted that the left controller 3 and the right controller 4 are also herein referred to as “controllers”.

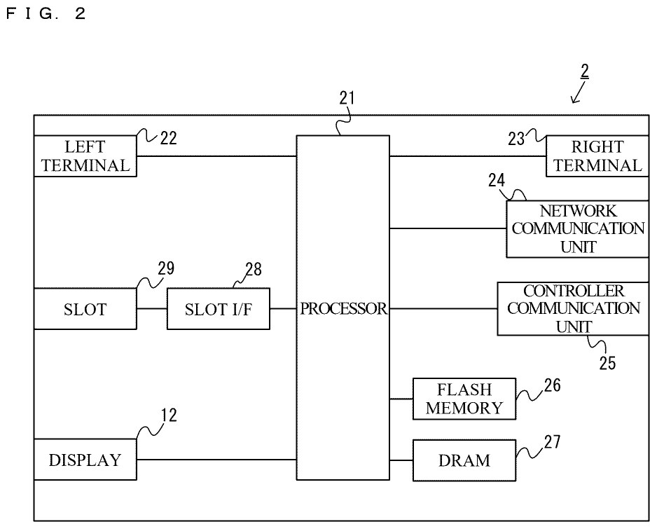

FIG. 2 is a block diagram showing an example of an internal configuration of the main body apparatus 2. As shown in FIG. 2, the main body apparatus 2 includes a processor 21. The processor 21 is an information processing unit that executes various information processes (e.g., a game process) that are executed by the main body apparatus 2. For example, the processor 21 includes at least one central processing unit (CPU) and at least one graphics processing unit (GPU). It should be noted that the processor 21 may only include a CPU, or may be configured by a system-on-a-chip (SoC) that has a plurality of functions such as a CPU function and a GPU function. The processor 21 executes an information processing program (e.g., a game program) or other instructions that are stored in storage (e.g., an internal non-transitory storage medium such as a flash memory 26, an external non-transitory storage medium attached to a slot 29, or the like), thereby executing various information processes.

The main body apparatus 2 further includes a display 12. The display 12 displays an image generated by the main body apparatus 2. In the present example, the display 12 is a liquid crystal display (LCD). However, the display 12 may be any type of display device. The display 12 is coupled to the processor 21. The processor 21 displays a generated image (e.g., an image generated by executing the above information processes) and/or an externally obtained image on the display 12.

The main body apparatus 2 further includes a left terminal 22 through which the main body apparatus 2 performs wired communication with the left controller 3, and a right terminal 23 through which the main body apparatus 2 performs wired communication with the right controller 4.

The main body apparatus 2 further includes a flash memory 26 and a dynamic random access memory (DRAM) 27 as an example of an internal storage medium included in the main body apparatus 2. The flash memory 26 and the DRAM 27 are coupled to the processor 21. The flash memory 26 is mainly used to store various types of data (or programs) that are stored in the main body apparatus 2. The DRAM 27 is used to temporarily store various types data that are used in information processing.

The main body apparatus 2 includes a slot 29. The slot 29 has a shape that allows a predetermined type of storage medium to be attached to the main body apparatus 2. The predetermined type of storage medium is, for example, a dedicated storage medium (e.g., a dedicated memory card) for the game system 1 or similar information processing apparatuses. The predetermined type of storage medium is used to store data (e.g., saved data of a game application or the like) that is used by the main body apparatus 2 and/or a program (e.g., a game program or the like) that is executed by the main body apparatus 2.

The main body apparatus 2 includes a slot interface (hereinafter abbreviated to “I/F”) 28. The slot I/F 28 is coupled to the processor 21. The slot I/F 28 is coupled to the slot 29, and reads and writes data from and to the predetermined type of storage medium (e.g., a dedicated memory card) attached to the slot 29 in accordance with instructions from the processor 21.

The processor 21 reads and writes data from and to the flash memory 26, the DRAM 27, and each of the above storage media as appropriate, thereby executing the above information processes.

The main body apparatus 2 includes a network communication section 24. The network communication section 24 is connected to the processor 21. The network communication section 24 communicates with an external apparatus via a network in a wireless or wired manner. In the present example, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication scheme (e.g., communication based on a particular protocol or infrared light communication). It should be noted that the wireless communication in the second communication form achieves the function of allowing so-called “local communication”, in which the main body apparatus 2 can wirelessly communicate with another main body apparatus 2 located in a closed local network area, and the plurality of main body apparatuses 2 exchange data with each other directly, or indirectly through an access point.

The main body apparatus 2 includes a controller communication section 25. The controller communication section 25 is coupled to the processor 21. The controller communication section 25 wirelessly communicates with the left controller 3 and/or the right controller 4. The communication method between the main body apparatus 2 and the left controller 3 and the right controller 4 is not particularly limited. In the present example, the controller communication section 25 performs communication with the left controller 3 and with the right controller 4 in accordance with the Bluetooth (registered trademark) standard.

The processor 21 is coupled to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. Thus, in the present example, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (an external display device, e.g., a television) other than the display 12.

### 2. Overview of Game

Next, a game that is executed in the game system 1 will be roughly described. In the present example, such a game is not particularly limited. As an example, a racing game is executed in which a user moves a player object in a virtual space using a controller. In the racing game, the player object may travel on a route set on a field in the virtual space, fly in the virtual space, and move underwater in the virtual space.

In the present example, the racing game has a single-player play mode in which the game is played by a single user, and a multiplayer play mode in which the game is played by a plurality of users. In the single-player play mode, the racing game is played using a player object operated by a user, and a plurality of traveling objects controlled by the processor 21. In the multiplayer play mode, the racing game is played using a plurality of player objects operated by respective users. For example, a plurality of controllers are connected to a single main body apparatus 2, and a plurality of users operates the respective corresponding player objects using their controllers, whereby the racing game is played in the multiplayer play mode. Alternatively, a plurality of main body apparatuses 2 are connected together directly or through a network (e.g., the Internet), and a plurality of users operate the respective corresponding player objects using their controllers connected to the respective main body apparatuses 2, whereby the racing game is played in the multiplayer play mode.

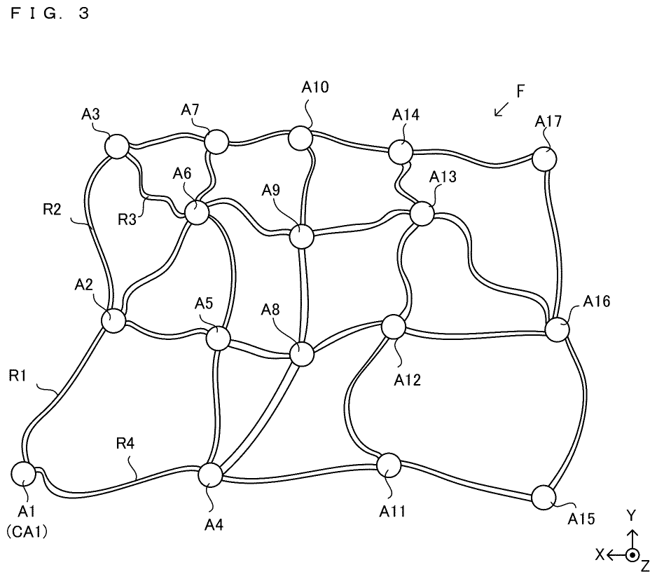

Here, in the present example, a field in the virtual space on which the racing game is played will be described. FIG. 3 is a diagram showing an example of an entire field F in the virtual space.

In the present example, a large field F is set in the virtual space (e.g., a three-dimensional space defined by an XYZ orthogonal coordinate system; and also referred to as a game space). The field F is, for example, set in parallel to the XY plane. It should be noted that the field F may undulate in a height direction (e.g., the Z-axis direction). Various courses are set on the field F. The racing game is played on the various courses.

As shown in FIG. 3, a plurality of base site areas A are set on the field F in the virtual space. For example, as the plurality of base site areas A, base site areas A1 to A17 are each represented by a circle. Each base site area A includes an intra-base site route CA, on which a player object corresponding to a user performs the racing game. For example, the base site area A1 indicates a town, and includes an intra-base site route CA1 that is formed by a road on which a player object is allowed to travel.

The plurality of base site areas are connected together by inter-base site routes R, on which a player object is allowed to travel. For example, the base site area A1 and the base site area A2 are connected together by an inter-base site route R1. The base site area A2 and the base site area A3 are connected together by an inter-base site route R2.

In the present example, a first racing game may be performed in which a player object and other traveling objects have a race on a course on which a plurality of laps are traveled around an intra-base site route CA provided in a base site area A (hereinafter referred to as an “intra-base site course”). In the present example, a second racing game may also be performed in which a player object and other traveling objects have a race on a course on which an inter-base site route R connecting a first base site area and a second base site area is traveled (hereinafter referred to as an “inter-base site course”).

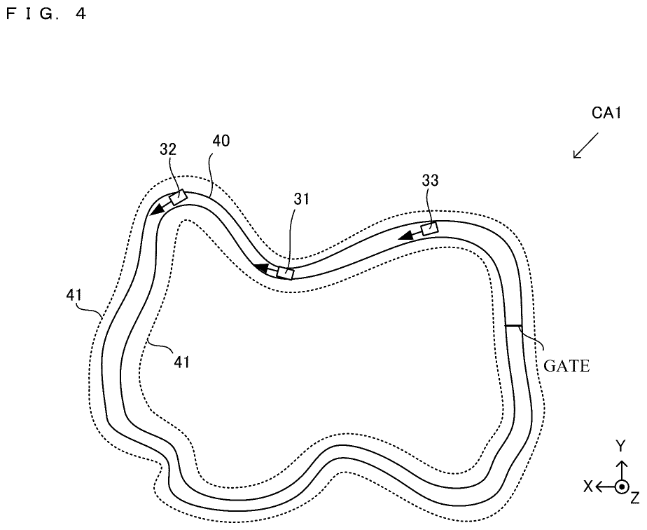

Firstly, the first racing game using an intra-base site course will be described. FIG. 4 is a diagram of an intra-base site course on which several laps are traveled around the intra-base site route CA1, as viewed from above in the virtual space, indicating an example of the first racing game using an intra-base site course.

As shown in FIG. 4, the base site area A1 includes the intra-base site route CA1. The intra-base site route CA1 is a route around which a plurality of traveling objects including a player object are allowed to travel a plurality of laps. A road 40 (a region surrounded by solid lines) on which a plurality of traveling objects are allowed to move is formed along the intra-base site route CA1. Travel permission regions 41 (e.g., regions between edges of the road 40 and dashed lines) are each set in a range extending by a predetermined distance from an edge of the road 40. The travel permission regions 41 are, for example, side roads next to the road 40. The intra-base site route CA1 is also provided with a gate that may serve as a start point and a finish point.

As shown in FIG. 4, for example, traveling objects 31 to 33 perform the racing game. The traveling object 31 is, for example, a player object operated by a first user. The traveling object 32 is a player object controlled by a second user. The traveling object 33 is a traveling object controlled by the processor 21. It should be noted that in addition to the traveling objects 31 to 33, a plurality of traveling objects controlled by other users or the processor 21 may take part in the racing game.

The traveling object 31 operated by the first user is hereinafter denoted as a “player object 31”. The traveling object controlled by the second user is denoted as a “traveling object 32”. The traveling object controlled by the processor 21 is denoted as a “traveling object 33”.

When the first racing game begins, a plurality of traveling objects including the player object 31, the traveling object 32, and the traveling object 33 start from the start point (e.g., the gate) of the intra-base site route CA1. The plurality of traveling objects are allowed to travel on the road 40 set along the intra-base site route CA1 or in the travel permission regions 41 beyond the road 40. It should be noted that the traveling objects may be allowed to temporarily leave the road 40 or the travel permission regions 41 and travel in the air during the racing game. The plurality of traveling objects reach the finish point (e.g., the gate) of the intra-base site route CA1 after traveling around the intra-base site route CA1 a plurality of laps.

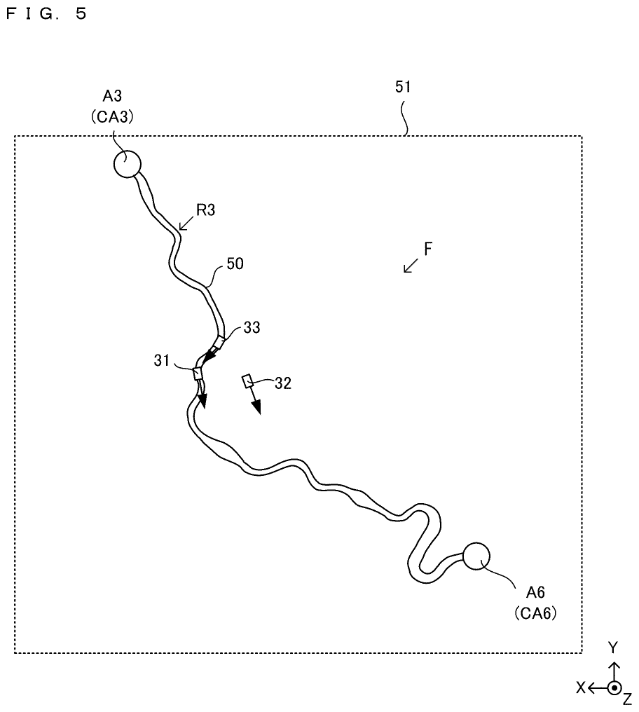

Next, the second racing game using an inter-base site course will be described. FIG. 5 is a diagram of an example of an inter-base site course including the inter-base site route R3 as viewed from above in the virtual space, indicating an example of the second racing game using an inter-base site course. As shown in FIG. 5, the base site area A3 and the base site area A6, and the inter-base site route R3 connecting the base site area A3 and the base site area A6, are set on the field F. In the present example, in the racing game, a plurality of traveling objects are allowed to perform the second racing game on an inter-base site course including an inter-base site route R connecting a first base site area and a second base site area. In the second racing game, a racing game (e.g., an open world game) in which a plurality of traveling objects travel in a wide range on the field F including an inter-base site route R can be performed.

As shown in FIG. 5, for example, the player object 31 and the traveling objects 32 and 33 perform the second racing game using the inter-base site course that starts from the base site area A3, passes through the inter-base site route R3, and reaches the base site area A6. The inter-base site route R3 is a route on which a plurality of traveling objects are recommended to move, and is formed by a road 50, for example.

In the second racing game, a plurality of traveling objects are allowed to travel on the inter-base site route R3 (e.g., on the road 50) and at positions on the field F other than the inter-base site route R3. Specifically, a plurality of traveling objects are allowed to travel in a travel permission region 51 that is a large range on the field F (e.g., a region surrounded by the dashed lines other than the road 50). For example, in FIG. 5, the player object 31 and the traveling object 33 are traveling on the inter-base site route R3, while the traveling object 32 is traveling in the travel permission region 51, but not on the inter-base site route R3. It should be noted that a plurality of traveling objects may be allowed to temporarily travel in the air during the racing game, leaving the road 50 and the travel permission region 51. The travel permission region 51 may include a water region, and traveling objects may be allowed to travel on the water or underwater.

The moving speed at which a traveling object travels at positions on the field other than the inter-base site route R3 is lower than the moving speed at which the traveling object travels on the inter-base site route R3. Meanwhile, the inter-base site route R3 includes curved portions, and therefore, when a traveling object travels at positions other than the inter-base site route R3, the distance by which the traveling object travels until reaching the finish point may be shorter than when traveling on the inter-base site route R3. Therefore, in the second racing game, the user is allowed to play the racing game while determining whether a player object corresponding to the user is caused to travel on the inter-base site route R3, or in the travel permission region 51, leaving the inter-base site route R3, to take a short cut.

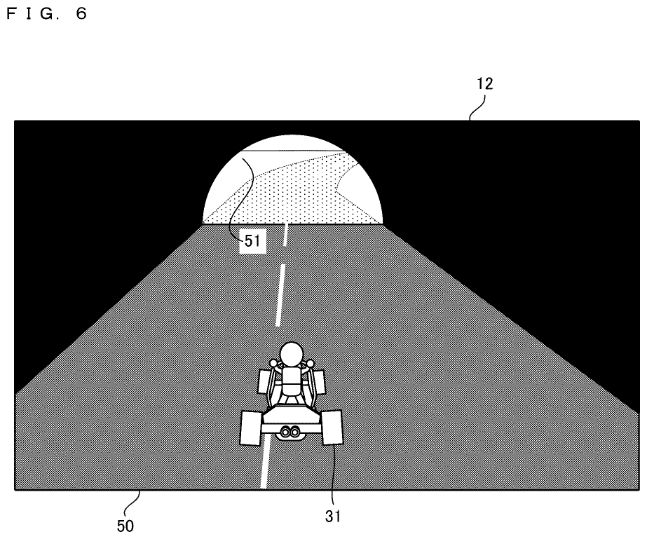

FIG. 6 is a diagram showing an example of a game image displayed during the racing game. As shown in FIG. 6, a game image based on a virtual camera whose gaze point is positioned a predetermined distance above a player object 31 from the back of the player object 31 corresponding to the main body apparatus 2 is displayed on a display device of the main body apparatus 2 (the display 12 or an external display device). In the example of FIG. 6, in the second racing game, the player object 31 is traveling on the road 50 forming the inter-base site route R3. A plurality of traveling objects may each travel on the road 50, or in the travel permission region 51, leaving the road 50.

In the present example, the game image is an image of the virtual space as viewed from the virtual camera that is rendered based on lighting settings corresponding to virtual time periods of day that transition according to the actual passage of time in game play. In the racing game shown in FIG. 6, the virtual space is rendered based on the lighting settings corresponding to the virtual time period of day corresponding to afternoon, and the player object 31 is traveling in a tunnel provided in the virtual space. When such a relatively dark scene is rendered, then if brightness correction is performed to increase the brightness of each pixel in a displayed image, the visibility of a portion in the vicinity of the traveling player object 31 is improved. Meanwhile, a display region of the virtual space outside the tunnel, that is relatively light when viewed from the relatively dark inside of the tunnel, may also be subjected to similar brightness correction that increases the brightness of pixels in the display region, resulting in a washed-out image, which deteriorates the visibility of the display region.

### 3. Overview of Luminance Correction

In the present example, a first luminance correction value for dark-place pixels and a second luminance correction value for light-place pixels are determined based on the brightness of a rendered scene. Of the rendered pixels, ones that have been determined are dark are subjected to luminance correction based on the first luminance correction value, and ones that have been determined are bright are subjected to luminance correction based on the second luminance correction value. As a result, in the present example, different types of luminance correction can be applied to dark-place pixels and light-place pixels based on the brightness of a rendered scene. Therefore, for example, a deterioration in the visibility of an image due to the above washing-out can be reduced.

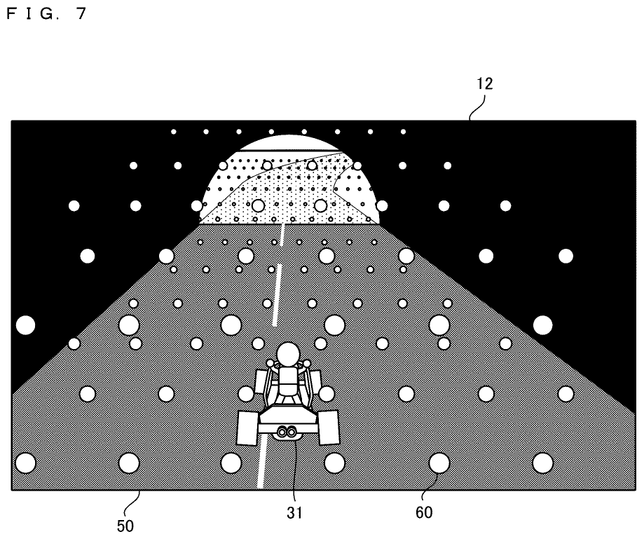

In the present example, as an example, the brightness of a scene is obtained based on a light probe(s). FIG. 7 is a diagram showing an example of light probes 60 arranged in the virtual space. As shown in FIG. 7, in the present example, the brightness of a rendered scene is obtained using the light probes. A plurality of light probes 60, which are data, are arranged in a world coordinate system in the virtual space in order to light the virtual space. For example, the light probes 60 are arranged in a grid pattern throughout the displayed scene of the virtual space, covering the entire region of the scene. As an example, for each of the light probes 60, data indicating the visibility factor of the sky (sky light) with respect to the world coordinate system, the illuminance and color of sunlight reflection, the illuminance and color of a disposed light source (emission/static light), and the like, together with data indicating the respective directivity, is stored as light probe data. Therefore, the light probe data can be used to calculate information indicating the color, intensity, and direction of illuminating light in the world coordinate system in which the light probes 60 are arranged. In addition, light probe data at any position in the world coordinate system in the virtual space can be calculated by interpolation based on the light probes 60. Furthermore, by calculating the brightness of a predetermined white sphere disposed at any position using the light probe data obtained by interpolation, the light probe data can be converted into the brightness at that position. It should be noted that the positions of the light probes 60 with respect to the entire displayed scene of the virtual space are not particularly limited.

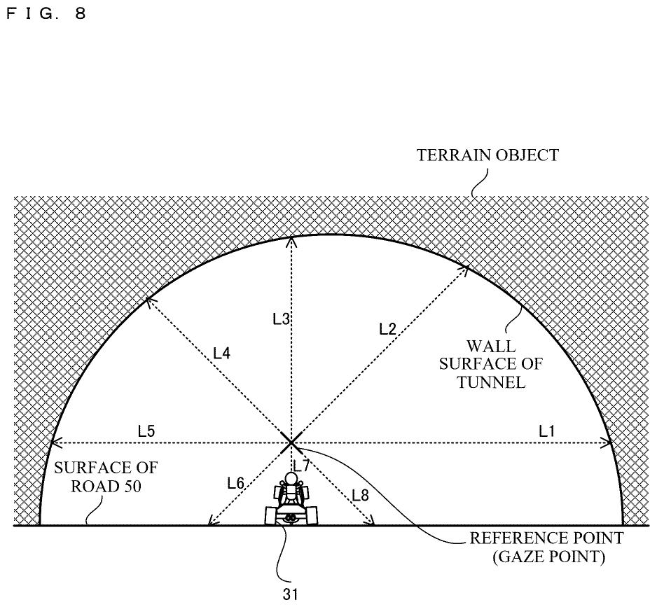

FIG. 8 is a diagram showing an example of ray casting that is performed in a predetermined direction from a gaze point in the virtual space. As illustrated in FIG. 8, in the present example, ray casting is performed in a predetermined direction from a reference point in the virtual space in order to set a plurality of sampling points in the virtual space. For example, the reference point is set based on the position of the gaze point of the virtual camera. In the present example, the gaze point of the virtual camera is set at any position in the virtual space and is, as an example, set a predetermined distance above the player object 31. It should be noted that the reference point may be set at the position in the virtual space coinciding with the gaze point of the virtual camera, or a position away from the gaze point by a predetermined distance and/or in a predetermined direction. As another example, the reference point may be set based on the position of the viewpoint of the virtual camera.

The game system 1 performs ray casting in all directions from the reference point for each rendering frame. For example, in the present example, ray casting is performed in a predetermined number of random directions from the reference point for each rendering frame, and the random directions for each rendering frame are smoothed over the plurality of rendering frames, so that ray casting can be performed in substantially all directions. As an example, in the example of FIG. 8, ray casting is performed in eight random directions from the reference point (when viewed from the virtual camera, ray casting L1 in a right direction, ray casting L2 in an upper-right direction, ray casting L3 in an upward direction, ray casting L4 in an upper-left direction, ray casting L5 in a left direction, ray casting L6 in a lower-left direction, ray casting L7 in a downward direction, and ray casting L8 in a lower-right direction). A collision position with respect to an object in the virtual space in each of the ray casting L1 to L8 in the eight directions is detected. In the example of FIG. 8, a collision position with respect to each of the wall surface of a tunnel disposed in the virtual space or the road surface of the road 50 is detected. It should be noted that in the present example, the directions in which ray casting is performed are randomly set, and therefore, may all be set to a direction different from the directions set in the previous rendering frame, or at least a portion of the directions may be the same direction as that which was set in the previous rendering frame. In the example of FIG. 8, for the sake of simplicity, the eight directions including the upward, downward, left, and right direction components as viewed from the virtual camera are illustrated as the directions in which ray casting is performed. In the present example, directions including forward and backward direction components of the virtual camera are randomly set.

It should be noted that the directions that are set in ray casting and the selection scheme are not particularly limited. Ray casting may be performed in directions limited to a predetermined range or in fixed directions set at regular intervals. For example, in the case in which ray casting is performed in all random directions with a position based on the gaze point set as the reference point, even when the position or line-of-sight direction of the virtual camera is instantaneously changed, ray casting can be performed appropriately for a scene that is rendered after the change. However, in another example, in the case in which it is not assumed that the position or line-of-sight direction of the virtual camera is instantaneously changed, ray casting may be performed in directions limited to a range excluding a backward direction of the virtual camera (e.g., a direction toward a range that is not viewed from the virtual camera). In that case, the reference point may be set to a position based on the viewpoint of the virtual camera, and ray casting may be performed from the reference point, in a predetermined number of directions that are forward directions of the virtual camera.

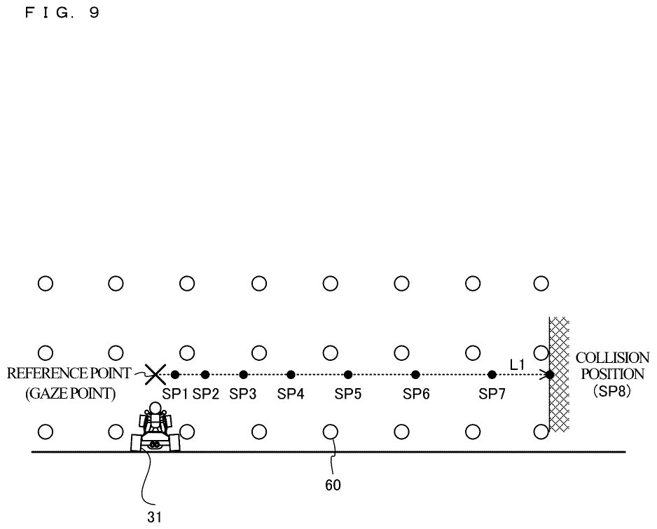

FIG. 9 is a diagram showing an example in which sampling points SP are set in the virtual space. As shown in FIG. 9, in the present example, a sampling point SP is set at, at least, a collision position with respect to an object in the virtual space in the ray casting L1 (SP8 in FIG. 9) and a predetermined number of positions (SP1 to SP7 in FIG. 9) between the reference point and the collision position. Here, in the present example, the sampling points SP set at positions between the reference point and the collision position are set such that more sampling points SP are set in regions closer to the reference point. In another example, the sampling points SP set at positions between the reference point and the collision position may be equally spaced. A sampling point SP may or may not be set at the collision position with respect to an object in the virtual space in the ray casting L1.

The game system 1 calculates the light probe data for each set sampling point SP. For example, the game system 1 interpolates the light probe data set for each light probe 60 into the world coordinates of the positions of the sampling points SP to calculate the light probe data with respect to the world coordinate system. For example, the light probes 60 used in the calculation may be those that are arranged within a predetermined distance from the sampling points SP, or may be a predetermined number of light probes 60 that are closest to the sampling points SP. In addition, when the light probe data is interpolated into the world coordinates of the positions of the sampling points SP, the light probe data of light probes 60 closer to the sampling points SP may be more weighted.

Next, when it is assumed that a predetermined white sphere is disposed at the world coordinates of the sampling points SP, the game system 1 calculates the degree of brightness to be rendered, based on the light probe data of each sampling point SP, taking into account the influence of shadow, sunlight (direct-light light source), or the like, to convert the light probe data of each sampling point SP into the brightness of the sampling point SP. Thereafter, the game system 1 weights the brightness of each sampling point SP obtained by the conversion such that a sampling point SP closer to the reference point is more weighted for ray casting in each direction, and adds up the brightnesses of the sampling points SP to obtain the total brightness of the sampling points SP set based on the current ray casting. Thereafter, the game system 1 smooths the total brightness of the sampling points SP based on ray casting of the current rendering frame, and the brightness based on all the sampling points SP obtained by ray casting of a past rendering frame, thereby obtaining the brightness of a scene in the current rendering frame. As an example, the game system 1 smooths the total brightness of the sampling points SP obtained by adding up the brightnesses of the sampling points SP based on ray casting of the current rendering frame, and the brightness of a scene obtained in the previous rendering frame, by performing predetermined weighting, to obtain the brightness of the scene in the current rendering frame.

In the foregoing description, the brightnesses of sampling points SP are added up with a greater weight given to a sampling point SP closer to the reference point, and more sampling points SP are set in regions closer to the reference point. Both or one of these weighting methods for obtaining the brightness of a scene may be performed. In the present example, when any of the weighting methods is performed, the brightness of a scene in which attention is paid to the brightness of a region in the virtual space close to the reference point can be obtained.

Next, the game system 1 calculates the first luminance correction value and the second luminance correction value based on the obtained brightness of the scene. The first luminance correction value is a dark-place luminance correction value used in luminance correction of dark-place pixels. The second luminance correction value is a light-place luminance correction value used in luminance correction of light-place pixels. In the present example, a first range (a first correction minimum value and a first correction maximum value) in which the first luminance correction value is set and a second range (a second correction minimum value and a second correction maximum value) in which the second luminance correction value is set are prepared according to the virtual time periods of day that transition according the actual passage of time of the racing game.

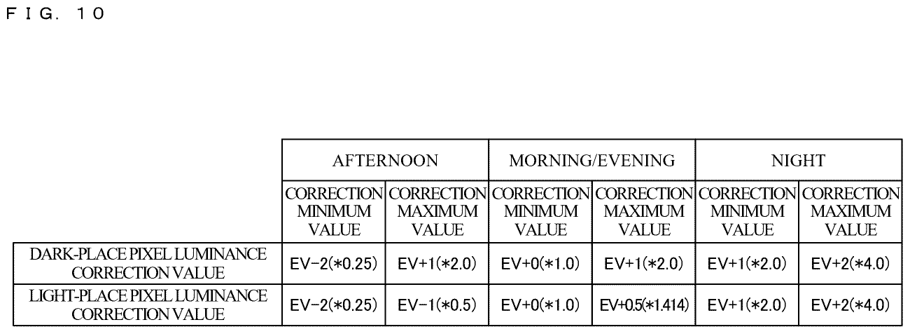

FIG. 10 is a diagram showing an example of luminance correction value ranges prepared for the virtual time periods of day. As shown in FIG. 10, in the present example, afternoon, morning/evening, and night are set as the virtual time periods of day, and a correction minimum value and a correction maximum value are set for each time period of day. For example, the correction minimum value and the correction maximum value are each expressed by the logarithmic value EV of a multiplication factor that is multiplied by the luminance of a pixel to correct the luminance. For example, EV−2 indicates that the luminance of a pixel is reduced by a factor of 4 (multiplied by 0.25), and EV+1 indicates that the luminance of a pixel is increased by a factor of 2 (multiplied by 2.0). The luminance correction value range includes a luminance correction value that corrects the luminance of a rendered pixel to a higher value and a luminance correction value that corrects the luminance of a rendered pixel to a lower value. When luminance correction is performed using the range, the luminance of a rendered pixel may be corrected to a higher value or a lower value. Specifically, EV−2 (0.25 fold) is set as a dark-place pixel correction minimum value (first correction minimum value) and EV+1 (2.0 fold) is set as a dark-place pixel correction maximum value (first correction maximum value) for the time period of day that is afternoon (the afternoon period). EV−2 (0.25 fold) is set as a light-place pixel correction minimum value (second correction minimum value) and EV−1 (0.5 fold) is set as a light-place pixel correction maximum value (second correction maximum value) for the afternoon period. Thus, luminance correction based on luminance correction values that reduce the luminance using EV−2 (0.25 fold) to EV−1 (0.5 fold) is applied to light-place pixels during the afternoon period. EV+0 (1.0 fold) is set as a dark-place pixel correction minimum value (first correction minimum value) and EV+1 (2.0 fold) is set as a dark-place pixel correction maximum value (first correction maximum value) for the time period of day that is morning/evening (the morning/evening period). EV+0 (1.0 fold) is set as a light-place pixel correction minimum value (second correction minimum value) and EV+0.5 (1.414 fold) is set as a light-place pixel correction maximum value (second correction maximum value) for the morning/evening period. Thus, during the morning/evening period, light-place pixels are corrected using EV+0 (1.0 fold) to EV+0.5 (1.414 fold), and are subjected to luminance correction based on luminance correction values that are the same as those for dark-place pixels or lower than those for dark-place pixels. EV+1 (2.0 fold) is set as a dark-place pixel correction minimum value (first correction minimum value) and EV+2 (4.0 fold) is set as a dark-place pixel correction maximum value (first correction maximum value) for the time period of day that is night (the night period). EV+1 (2.0 fold) is set as a light-place pixel correction minimum value (second correction minimum value) and EV+2 (4.0 fold) is set as a light-place pixel correction maximum value (second correction maximum value) for the night period. Thus, during the night period, the same correction multiplication factor is set for light-place pixels and dark-place pixels.

In the present example, determination minimum values and determination maximum values related to the brightness of a scene are set, corresponding to the correction minimum values and the correction maximum values for the virtual time periods of day. When the brightness of a rendered scene during the time period of day of the scene is lower than or equal to the determination minimum value of the time period of day of the scene, the game system 1 determines that a dark-place pixel first luminance correction value EVa is the first correction maximum value and a light-place pixel second luminance correction value EVb is the second correction maximum value. When the brightness of a rendered scene during the time period of day of the scene is higher than or equal to the determination maximum value of the time period of day of the scene, the game system 1 determines that the dark-place pixel first luminance correction value EVa is the first correction minimum value and the light-place pixel second luminance correction value EVb is the second correction minimum value. When the brightness of a rendered scene during the time period of day of the scene is between the determination minimum value and the determination maximum value of the time period of day of the scene, the game system 1 determines that the dark-place pixel first luminance correction value EVa is a value between the first correction minimum value and the first correction maximum value, and the light-place pixel second luminance correction value EVb is a value between the second correction minimum value and the second correction maximum value, these values being calculated by interpolation based on the brightness. It should be noted that when the virtual time period of day of a rendered scene is transitioning, the game system 1 may determine the first luminance correction value EVa and the second luminance correction value EVb by interpolation using the first luminance correction values EVa and the second luminance correction values EVb corresponding to the time periods of day before and after the transition, based on the degree of transition of the time period of day (e.g., elapsed transition time). Thus, in the case in which the luminance correction value range is prepared according to the virtual time periods of day, an increase in the luminance correction of the light-place pixel second luminance correction value EVb may be small compared to the luminance correction using the dark-place pixel first luminance correction value EVa for the afternoon and morning/evening periods, and an increase in the luminance correction using the dark-place pixel first luminance correction value EVa may be the same as an increase in the luminance correction of the light-place pixel second luminance correction value EVb for the night period, so that the increase may also be the same for the afternoon and morning/evening periods.

In the present example, as a screen effect on a rendered scene, the luminance correction based on the first luminance correction value EVa is applied to pixels that satisfy a condition under which it is determined that a pixel is dark, and the luminance correction based on the second luminance correction value EVb is applied to pixels that satisfy a condition under which it is determined that a pixel is bright. For example, the game system 1 determines that a rendered pixel is a dark-place pixel if the pixel satisfies the condition that the luminance of the pixel is lower than a pixel luminance threshold, and a light-place pixel if the pixel satisfies the condition that the luminance of the pixel is higher than or equal to the pixel luminance threshold. The pixel luminance threshold may be a value (e.g., 0.15) that is fixed irrespective of the virtual time period of day, or may be changed, depending on the time period of day or other parameters. As an example, in the latter case, the pixel luminance threshold may be changed to a greater value for a time period of day during which it is lighter (e.g., afternoon), and to a lower value for a time period of day during which it is darker (e.g., night). When the time period of day is transitioning, the pixel luminance threshold may be set by interpolation using the pixel luminance thresholds corresponding to the time periods of day before and after the transition, based on the degree of the transition of the time period of day (e.g., elapsed transition time) or the brightness during the transition of the time period of day. As another example, the pixel luminance threshold may be set to a value that is changed, depending on the season, weather, travel environment, or the like.

Although in the foregoing description, a pixel that satisfies the condition that the luminance of the pixel is higher than or equal to the pixel luminance threshold is regarded as a pixel that satisfies a condition under which it is determined that a pixel is bright. This expression has the same meaning as that of the expression that a pixel that satisfies the condition that the luminance of the pixel is higher than or equal to the pixel luminance threshold is regarded as a pixel that satisfies a condition under which it is determined that a pixel is not dark or the expression that a pixel that satisfies the condition that the luminance of the pixel is higher than or equal to the pixel luminance threshold is regarded as a pixel that satisfies a condition under which it is not determined that a pixel is dark. In addition, although a pixel that satisfies the condition that the luminance of the pixel is lower than the pixel luminance threshold is regarded as a pixel that satisfies a condition under which it is determined that a pixel is dark, this expression has the same meaning as that of the expression that a pixel that satisfies the condition that the luminance of the pixel is lower than the pixel luminance threshold is regarded as a pixel that satisfies a condition under which it is determined that a pixel is not bright or the expression that a pixel that satisfies the condition that the luminance of the pixel is lower than the pixel luminance threshold is regarded as a pixel that satisfies a condition under which it is not determined that a pixel is bright.

Although in the foregoing description, it is determined that a pixel is a dark-place pixel or a light-place pixel by determining whether the luminance of the pixel is “lower” or “higher than or equal to” the pixel luminance threshold, it may be determined that a pixel is a dark-place pixel or a light-place pixel by determining whether the luminance of the pixel is “lower than or equal to” or “higher than (exceed)” the pixel luminance threshold. In that case, needless to say, by changing the pixel luminance threshold to a value that is smaller by the smallest unit (difference) of the luminance that is noticeable, the same luminance ranges can be used to distinguish dark-place pixels from light-place pixels.

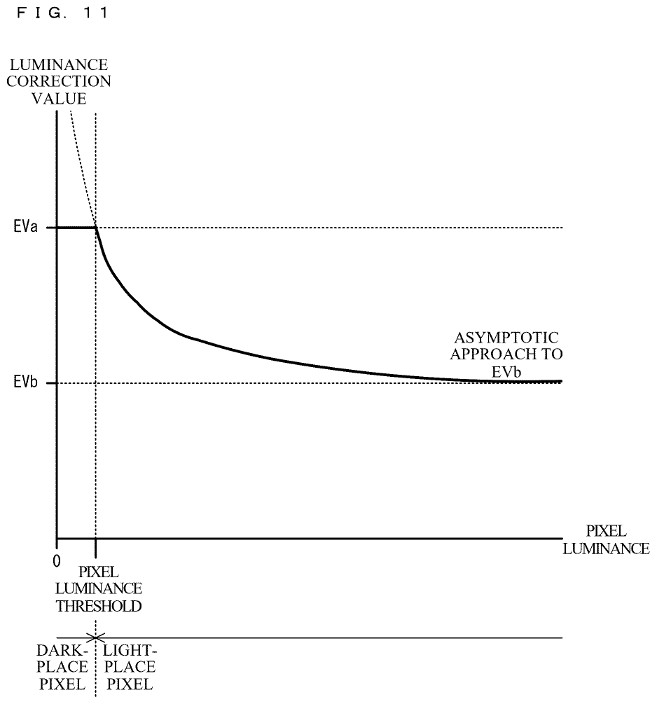

FIG. 11 is a graph showing an example of luminance correction values applied to the luminance of a rendered pixel. As shown in FIG. 11, the game system 1 performs luminance correction for changing the luminance of a pixel using a magnification factor depending on the first luminance correction value EVa, on dark-place pixels whose luminance is lower than the pixel luminance threshold. The game system 1 also performs luminance correction for changing the luminance of a pixel using a magnification factor that becomes closer to a magnification factor depending on the second luminance correction value EVb from the above magnification factor as the luminance increases from the pixel luminance threshold, on light-place pixels whose luminance is higher than or equal to the pixel luminance threshold. For example, the game system 1 performs, on dark-place pixels, luminance correction for changing the luminance of a pixel using a multiplication factor a logarithmic value of which is the first luminance correction value EVa. The game system 1 also performs, on light-place pixels, luminance correction for changing the luminance of a pixel using a multiplication factor a logarithmic value of which is a value that asymptotically becomes closer to the second luminance correction value EVb from the first luminance correction value EVa as the luminance increases from the pixel luminance threshold. Thus, by using the luminance correction value that becomes closer to the magnification factor applied to light-place pixels from the magnification factor applied to dark-place pixels as the luminance increases from the pixel luminance threshold, the luminances of pixels after luminance correction using the applied luminance correction value can be adjusted to increase continuously and monotonically even in a boundary between dark-place pixels and light-place pixels.

It should be noted that the game system 1 may apply different luminance correction values to dark-place pixels and light-place pixels based on other application mathematical expressions. As an example, the game system 1 may perform, on light-place pixels, luminance correction for changing the luminance of a pixel using a magnification factor depending on the second luminance correction value EVb and, on dark-place pixels, luminance correction for changing the luminance of a pixel using a magnification factor that becomes closer to a magnification factor depending on the first luminance correction value EVa from that magnification factor as the luminance decreases from the pixel luminance threshold. As another example, the game system 1 may perform, on dark-place pixels, luminance correction for changing the luminance of a pixel using a magnification factor that becomes closer to a magnification factor depending on the first luminance correction value EVa as the luminance decreases from the pixel luminance threshold and, on light-place pixels, luminance correction for changing the luminance of a pixel using a magnification factor that becomes closer to a magnification factor depending on the second luminance correction value EVb as the luminance increases from the pixel luminance threshold. In the foregoing description, as an example in which the magnification factor for luminance correction becomes closer to a magnification factor depending on the luminance correction value as the luminance decreases and/or increases from the pixel luminance threshold, the application mathematical expression that provides such asymptotic approach to the magnification factor is illustrated. The application mathematical expression that provides approach to the magnification factor is not particularly limited. For example, the application mathematical expression that provides approach to the magnification factor may be defined by a linear function, or a nonlinear function such as a quadratic or higher function, logarithmic curve, or exponential function.

For rendered pixels, the game system 1 performs luminance correction on dark-place pixels using a luminance correction value for dark-place pixels, and light-place pixels using a luminance correction value for light-place pixels, and displays an image after the luminance correction on a display device. For example, the game system 1 calculates a luminance correction value corresponding to the luminance of each pixel rendered in a predetermined frame buffer using the applied luminance correction mathematical expression, and multiplies the luminance by a magnification factor indicated by the luminance correction value (e.g., multiplied by the calculated luminance correction value as a logarithmic value of a multiplication factor), to perform luminance correction on the pixel.

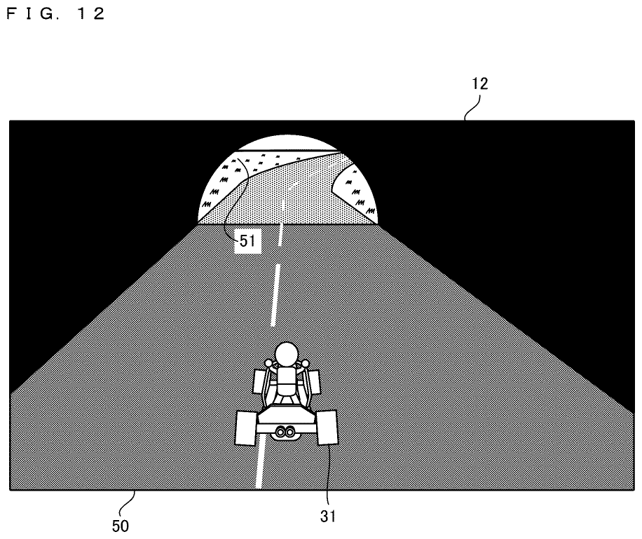

FIG. 12 is a diagram showing an example of luminance correction performed on dark-place pixels based on the first luminance correction value EVa, and luminance correction performed on light-place pixels based on the second luminance correction value EVb, for the game image of FIG. 6. As described above, in the game image of FIG. 6, the virtual space is rendered based on lighting settings for the afternoon period. For the game image thus rendered, the game system 1 determines the first luminance correction value EVa and the second luminance correction value EVb in the luminance correction value range for the afternoon period (see FIG. 10) based on the brightness of a rendered scene. The game system 1 determines that pixels rendered as the inside of a tunnel in which the player object 31 is traveling are a dark-place pixel, and performs luminance correction based on the first luminance correction value EVa, and further, determines that pixels rendered as the outside of the tunnel are a light-place pixel, and performs luminance correction based on the second luminance correction value EVb. As a result, in a game image after the luminance correction when the brightness of the scene is low because the player object 31 is traveling in the dark tunnel, dark-place pixels rendered as the inside of the tunnel are subjected to luminance correction for increasing the brightness, and therefore, a deterioration in the visibility of the game image due to insufficient brightness is reduced, resulting in an improvement in the visibility of the game image indicating the inside of the tunnel in which the player object 31 is traveling. In addition, light-place pixels rendered as the outside of the tunnel viewed from the inside of the tunnel are subjected to luminance correction for reducing the brightness, and therefore, a deterioration in the visibility of the game image due to washing-out or the like can be reduced, which allows the user to more easily see the road 50 outside the tunnel.

It should be noted that the above luminance correction is suitable for a game in which the virtual time period of day transitions according to the passage of time of the actual world in which a game is played, and the virtual space is rendered based on lighting settings according to the transition of the time period of day. For example, in the above racing game, intra-base site routes and inter-base site routes are distributed on the single field F, traveling is allowed in a region outside the routes in addition to a race using an intra-base site course along an intra-base site route and a race using an inter-base site course along an inter-base site route, and an open world game in which traveling is allowed in a large range on the field F can be played. In this case, compared to a game in which different game stages are set for different courses used in a race, and a time period of day is set for each game stage, various races using a plurality of courses or an open world game are played using an environment in which virtual time elapses throughout the large field F, and therefore, the virtual time period of day easily transitions. In the case in which a game image is rendered in a game in which the virtual time period of day thus easily transitions, because luminance correction according to the time period of day or luminance correction based on a lighting environment having sharp changes can be performed in the present example, and therefore, the present example is suitable for the game. In addition, in the present example, the brightness of a scene rendered using the light probe data arranged in the virtual space is obtained, but not the brightness of rendered pixels, and therefore, the processing load for obtaining the brightness of the scene can be reduced, and the present example is suitable for rendering of a game image in which the viewpoint is quickly moved by causing the virtual camera to follow a player object traveling at a high speed.

### 4. Specific Example of Processing in Game System

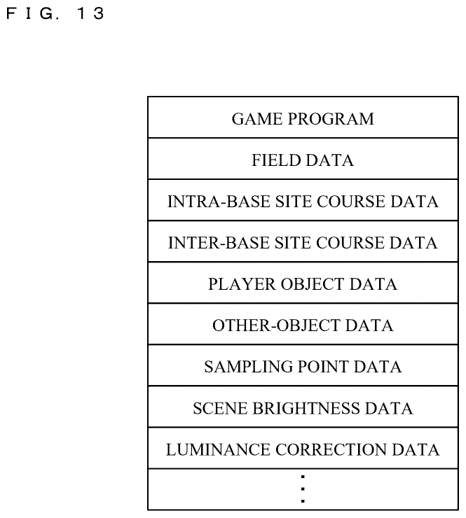

Next, a specific example of information processing in the game system 1 will be described with reference to FIGS. 13 to 15.

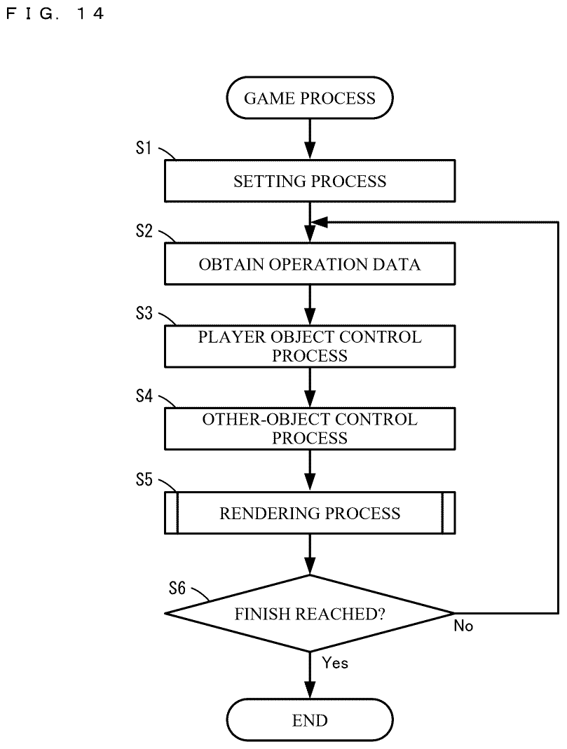

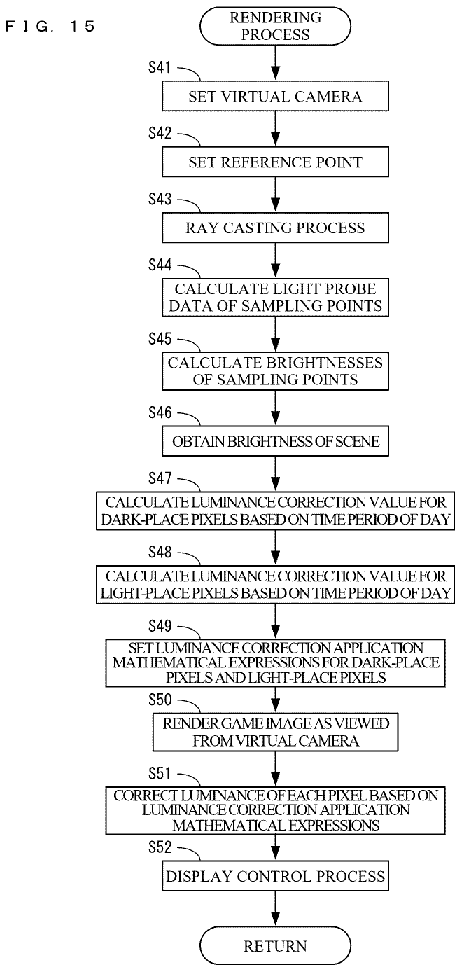

FIG. 13 is a diagram showing an example of various data used in information processing in the game system 1. The data shown in FIG. 13 are stored in a memory (e.g., the flash memory 26, the DRAM 27, and/or a memory card attached to the slot 29) that is accessible by the main body apparatus 2. As shown in FIG. 13, the game system 1 stores a game program therein. The game program is a program for executing game processing (e.g., game processing shown in FIGS. 14 and 15) in the present example. The memory stores field data, intra-base site course data, inter-base site course data, player object data, other-object data, sampling point data, scene brightness data, luminance correction data, and the like.

The field data indicates the entire field F. The field data includes data indicating a plurality of base site areas and data indicating a plurality of inter-base site routes.

The intra-base site course data is related to intra-base site courses on which the first racing game is played. The inter-base site course data is related to inter-base site courses on which the second racing game is played.

The player object data is related to the player object 31 controlled by the user of the game system 1. The player object data includes data indicating the shape, type, and the like of the player object 31, data indicating the position, pose, state, motion, and the like of the player object 31, and the movement information (speed, acceleration, movement direction, and the like) of the player object 31.

The other-object data is related to other objects including a plurality of traveling objects including traveling objects 32 operated by other users and traveling objects 33 operated by the processor 21, and the like. As with the player object data, the other-object data includes data indicating the shapes, types, and the like of traveling objects, data indicating the positions, poses, states, motions, and the like of traveling objects, and the movement information of traveling objects.

The sampling point data is related to the world coordinates, light probe data, brightnesses, and the like of sampling points SP (see FIG. 9) in the virtual space.

The scene brightness data indicates the brightness of a rendered scene, and includes history data indicating the brightness of a scene obtained in a past rendering frame (e.g., data indicating the brightness of a scene obtained in the previous rendering frame).

The luminance correction data is used in luminance correction performed on each of dark-place pixels and light-place pixels, and includes the first luminance correction value EVa, the second luminance correction value EVb, an application mathematical expression indicating a luminance correction value applied to the luminance of a rendered pixel (see FIG. 11), and the like.

FIG. 14 is a flowchart showing an example of a flow of game processing executed by the game system 1. FIG. 15 is a subroutine showing an example of a rendering process executed in step S5 of FIG. 14. Execution of the game processing is started in response to the game having been started according to an instruction of the user, during execution of the game program, for example. A processing loop composed of a series of processes in steps S1 to S6 is performed in a cycle of once for each frame.

In the present example, the processor 21 of the main body apparatus 2 executes the game program stored in the game system 1 to execute processes in steps shown in FIGS. 14 and 15. However, in other examples, a part of the processes in the steps may be executed by a processor (e.g., a dedicated circuit or the like) other than the processor 21. Further, if the game system 1 is communicable with another information processing apparatus (e.g., a server), a part of the processes in the steps shown in FIGS. 14 and 15 may be executed by the other information processing apparatus. The processes in the steps shown in FIGS. 14 and 15 are merely examples, and the processing order of the steps may be changed, or another process may be executed in addition to (or instead of) the processes in the steps as long as similar results can be obtained.

The processor 21 executes the processes in the steps shown in FIGS. 14 and 15 by using a memory (e.g., the DRAM 85). That is, the processor 21 stores information (in other words, data) obtained in each process step, into the memory, and reads out the information from the memory when using the information for the subsequent process steps.

In FIG. 14, the processor 21 executes a setting process (step S1), and proceeds to the next step. For example, the processor 21 sets intra-base site courses on which the first racing game is played and inter-base site courses on which the second racing game is played, based on the user's operation. The processor 21 also arranges a plurality of traveling objects including the player object 31 at a start point of a course selected by the user. Thereafter, the processor 21 starts a racing game using the course.

Next, the processor 21 obtains operation data indicating an operation input performed by the user (step S2), and proceeds to the next step. For example, the processor 21 obtains operation data and the like output from the controller operated by the user through the controller communication section 25 and/or the terminals 22 and 23.

Next, the processor 21 executes a player object control process (step S3), and proceeds to the next step. For example, the processor 21 updates information related to the player object 31 based on the operation data obtained in step S2. As an example, the processor 21 updates, based on the operation data, the position, pose, motion, speed, direction, state, and the like of the player object 31. If in step S3, the information related to the player object 31 is changed, the processor 21 updates the player object data related to the player object 31 and stored in the memory such that the data indicates the changed contents.

Next, the processor 21 executes an other-object control process (step S4), and proceeds to the next step. For example, the processor 21 controls a traveling object 32 operated by another user and a traveling object 33 controlled by the processor 21 in the virtual space, and updates information related to the traveling objects. As an example, the processor 21 updates the position, pose, motion, speed, direction, state, and the like of the traveling object 32 based on data received from the game system 1 of the another user. The processor 21 also updates the position, pose, motion, speed, direction, state, and the like of the traveling object 33 based on a predetermined algorithm. If in step S4, the information related to a traveling object is changed, the processor 21 updates the other-object data related to the traveling object and stored in the memory such that the data indicates the changed contents.

Next, the processor 21 executes a rendering process (step S5), and proceeds to step S6. The rendering process executed in step S5 will be described below with reference to FIG. 15.

In FIG. 15, the processor 21 sets a virtual camera in the virtual space (step S41), and proceeds to the next step. For example, the processor 21 refers to the player object data, and sets the position of the virtual camera to a predetermined position where the virtual camera follows the player object 31, and sets the orientation of the virtual camera such that the gaze point of the virtual camera is positioned a predetermined distance above the player object 31 (see FIGS. 8 and 9). It should be noted that the position and orientation of the virtual camera are not particularly limited, and may be changed based on the operation data of the user.

Next, the processor 21 sets a reference point for performing ray casting (step S42), and proceeds to the next step. It should be noted that the reference point is set in accordance with the method described above in [3. Overview of Luminance Correction].

Next, the processor 21 executes a ray casting process (step S43), and proceeds to the next step. For example, the processor 21 performs ray casting in a predetermined number of random directions from the reference point, and sets sampling points based on the result of each ray casting (see FIGS. 8 and 9, and [3. Overview of Luminance Correction]). In step S43, the processor 21 updates the sampling point data stored in the memory using data indicating the positions (world coordinates) of the set sampling points.

Next, the processor 21 calculates the light probe data for each sampling point set in step S43 (step S44), and proceeds to the next step. For example, the processor 21 calculates the light probe data for each sampling point in accordance with the method described above in [3. Overview of Luminance Correction]. In step S44, the processor 21 updates the sampling point data stored in the memory using the calculated light probe data for each sampling point.

Next, the processor 21 calculates the brightness of each sampling point using the light probe data calculated in step S44 (step S45), and proceeds to the next step. For example, the processor 21 calculates the brightness of each sampling point in accordance with the method described above in [3. Overview of Luminance Correction]. In step S45, the processor 21 updates the sampling point data stored in the memory using the calculated brightness of each sampling point.

Next, the processor 21 adds up the brightnesses of the sampling points calculated in step S45, to obtain the brightness of a scene that is rendered in the rendering frame (step S46), and proceeds to the next step. For example, the processor 21 smooths the brightness of a scene obtained by adding up the brightnesses of the sampling points in the current rendering frame and the brightness of the scene obtained in a past (e.g., the previous) rendering frame, by performing predetermined weighting, to obtain the brightness of the scene in the current rendering frame in accordance with the method described above in [3. Overview of Luminance Correction]. In step S46, the processor 21 updates the scene brightness data stored in the memory using the obtained brightness of the scene in the current rendering frame.

Next, the processor 21 calculates a luminance correction value for dark-place pixels based on the current virtual time period of day in the virtual world (step S47), and proceeds to the next step. For example, the processor 21 calculates a luminance correction value for dark-place pixels corresponding to the brightness of the scene obtained in step S46 (e.g., the first luminance correction value EVa) in accordance with the method described above in [3. Overview of Luminance Correction]. In step S47, the processor 21 updates the luminance correction data stored in the memory using the calculated luminance correction value for dark-place pixels.

Next, the processor 21 calculates a luminance correction value for light-place pixels based on the current virtual time period of day in the virtual world (step S48), and proceeds to the next step. For example, the processor 21 calculates a luminance correction value for light-place pixels corresponding to the brightness of the scene obtained in step S46 (e.g., the second luminance correction value EVb) in accordance with the method described above in [3. Overview of Luminance Correction]. In step S48, the processor 21 updates the luminance correction data stored in the memory using the calculated luminance correction value for light-place pixels.

Next, the processor 21 calculates a luminance correction application mathematical expression corresponding to the luminance correction value for dark-place pixels and a luminance correction application mathematical expression corresponding to the luminance correction value for light-place pixels (step S49), and proceeds to the next step. For example, the processor 21 calculates a luminance correction application mathematical expression corresponding to the luminance correction value for dark-place pixels calculated in step S47 and a luminance correction application mathematical expression corresponding to the luminance correction value for light-place pixels calculated in step S48 (see FIG. 11) in accordance with the method described above in [3. Overview of Luminance Correction]. In step S49, the processor 21 updates the luminance correction data stored in the memory using the calculated luminance correction application mathematical expressions.

Next, the processor 21 renders a game image of the virtual space as viewed from the virtual camera (step S50), and proceeds to the next step. For example, the processor 21 outputs a game image of the virtual space as viewed from the virtual camera set in step S41 to a predetermined frame buffer to render the game image (see FIG. 6).

Next, the processor 21 corrects the luminance of each rendered pixel based on the luminance correction application mathematical expression (step S51), and proceeds to the next step. For example, the processor 21 performs luminance correction on pixels rendered in the frame buffer in step S50, based on the luminances of the pixel, in accordance with the method described above in [3. Overview of Luminance Correction].

Next, the processor 21 executes a display control process of displaying a game image to which luminance correction has been applied, on a display device (e.g., the display 12) (step S52), and ends the subroutine. For example, the processor 21 performs control to output the game image that has been rendered in the frame buffer after luminance correction has been applied thereto in step S51 to the display device, thereby displaying the game image on the display device (see FIG. 12).

Referring back to FIG. 14, after the rendering process in step S5, the processor 21 determines whether or not the finish has been reached (step S6). For example, the processor 21 determines whether or not all traveling objects including the player object 31 and the traveling objects 32 and 33 have reached the finish point set for the currently used course. If all traveling objects have reached the finish, the result of the determination by the processor 21 in step S6 is positive, the result of the current acing game is displayed, and the game processing is ended. Meanwhile, if not all traveling objects have reached the finish, the result of the determination by the processor 21 in step S6 is negative, and the process in step S2 is executed again. The racing game is caused to proceed by repeated execution of a series of processes in steps S21 to S6.

Thus, in the present example, different types of luminance correction can be performed on rendered dark-place pixels and light-place pixels based on the brightness of a rendered scene. As a result, for example, because luminance correction for increasing brightness is performed on dark-place pixels and luminance correction for decreasing brightness is performed on light-place pixels, a deterioration in the visibility of a game image due to washing-out or the like can be reduced while a deterioration in the visibility of a game image due to insufficient brightness or the like can be reduced.

Although the above examples have been described using a game image that is rendered in a racing game in which an open world game in which traveling is performed in a wide range on the field F, the present example may be applied to game images that are rendered in other racing games or any games. The present example may be applied to not only a game image that is rendered in a game process in which any game is played, but also an image that is rendered in any information process or the like.

It should be noted that the game system 1 may be any suitable apparatus, including handheld game apparatuses, personal digital assistants (PDAs), mobile telephones, smartphones, personal computers, cameras, tablet computers, and the like. In that case, an input apparatus for performing a user operation of moving a player character or the like may not be the left controller 3, the right controller 4, or the like, and may be other controllers, a mouse, a touch pad, a touch panel, a trackball, a keyboard, a directional pad, a slide pad, or the like.

In the foregoing, each information process is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 21 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the information processing apparatus 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is usable as an image processing program, image processing method, image processing system, image processing apparatus, and the like that are capable of performing brightness correction according to the brightness of a scene in various situations or the like in a game and the like.

What is claimed is:

1. A non-transitory computer-readable storage medium having stored therein an image processing program that when executed, causes one or more processors of an information processing apparatus to execute operations comprising:
rendering a virtual space;
obtaining the brightness of a rendered scene;
determining a first luminance correction value in a first range and a second luminance correction value in a second range based on the brightness of the scene; and
for rendered pixels, based on the luminances of the pixels,
performing luminance correction based on the first luminance correction value, on pixels satisfying a condition under which it is determined that a pixel is dark, and
performing luminance correction based on the second luminance correction value, on pixels satisfying a condition under which it is determined that a pixel is bright.

2. The non-transitory computer-readable storage medium according to claim 1, wherein
the operations further comprise:
rendering the virtual space based on lighting settings related to virtual time periods of day that transition according to the passage of time.

3. The non-transitory computer-readable storage medium according to claim 2, wherein
the first range is a range between a first correction minimum value and a first correction maximum value,
the second range is a range between a second correction minimum value and a second correction maximum value, and
the first correction minimum value, the first correction maximum value, the second correction minimum value, and the second correction maximum value are each set in association with each of the virtual time periods of day.

4. The non-transitory computer-readable storage medium according to claim 3, wherein
a determination minimum value and a determination maximum value related to the brightness of the scene are set in association with each of the virtual time periods of day, and
the operations further comprise:
when the brightness of the scene is lower than or equal to the determination minimum value, determining that the first luminance correction value is the first correction maximum value, and the second luminance correction value is the second correction maximum value;
when the brightness of the scene is higher than or equal to the determination maximum value, determining that the first luminance correction value is the first correction minimum value, and the second luminance correction value is the second correction minimum value; and
when the brightness of the scene is between the determination minimum value and the determination maximum value, determining that the first luminance correction value is a value between the first correction minimum value and the first correction maximum value, and the second luminance correction value is a value between the second correction minimum value and the second correction maximum value, by interpolation based on the brightness.

5. The non-transitory computer-readable storage medium according to claim 3, wherein
the operations further comprise:
setting the second correction maximum value to a value smaller than the first correction maximum value, in association with a first time period of day of the virtual time periods of day; and
setting the first correction minimum value and the second correction minimum value to the same value, and the first correction maximum value and the second correction maximum value to the same value, in association with a second time period of day of the virtual time periods of day.

6. The non-transitory computer-readable storage medium according to claim 2, wherein
the condition under which it is determined that a pixel is dark is that the luminance of the pixel is lower than a threshold set in association with the virtual time periods of day, and
the condition under which it is determined that a pixel is bright is that the luminance of the pixel is higher than or equal to the threshold.

7. The non-transitory computer-readable storage medium according to claim 1, wherein
the condition under which it is determined that a pixel is dark is that the luminance of the pixel is lower than a threshold, and
the condition under which it is determined that a pixel is bright is that the luminance of the pixel is higher than or equal to the threshold.

8. The non-transitory computer-readable storage medium according to claim 7, wherein
the operations further comprise:
performing the luminance correction on a pixel whose luminance is lower than the threshold, by changing the luminance of the pixel by a first magnification factor depending on the first luminance correction value; and
performing the luminance correction on a pixel whose luminance is higher than or equal to the threshold, by changing the luminance of the pixel by a second magnification factor that further approaches from the first magnification factor to a magnification factor depending on the second luminance correction value as the luminance increases from the threshold.

9. The non-transitory computer-readable storage medium according to claim 1, wherein
the operations further comprise:
obtaining the brightness of the rendered scene based on a light probe disposed in the virtual space.

10. The non-transitory computer-readable storage medium according to claim 9, wherein
the operations further comprise:
obtaining the brightnesses of a plurality of sampling points set in the scene, based on the light probes arranged around positions in the virtual space related to the plurality of sampling points, and obtaining the brightness of the scene based on the brightnesses of the plurality of sampling points.

11. The non-transitory computer-readable storage medium according to claim 10, wherein
the operations further comprise:
performing ray casting in a direction from a reference point in the virtual space, and setting the sampling point at, at least, a collision position of the ray casting with respect to an object in the virtual space, and one or more positions between the reference point and the collision position.

12. The non-transitory computer-readable storage medium according to claim 11, wherein
the reference point is set based on a position of a gaze point of a virtual camera.

13. The non-transitory computer-readable storage medium according to claim 12, wherein
the operations further comprise:
performing the ray casting in one or more random directions for each rendering frame, and smoothing the brightness based on the sampling points due to the ray casting, and the brightness based on the sampling points due to the ray casting in a past frame, to obtain the brightness of the scene.

14. The non-transitory computer-readable storage medium according to claim 11, wherein
the operations further comprise at least one of:
giving a greater weight to the sampling point closer to the reference point, and obtaining the total brightness of the plurality of sampling points as the brightness of the scene; and
setting more sampling points in regions closer to the reference point, between the reference point and the collision position caused by the ray casting.

15. An image processing method performed on an information processing system, the image processing method comprising:
rendering a virtual space;
obtaining the brightness of a rendered scene;
determining a first luminance correction value in a first range and a second luminance correction value in a second range based on the brightness of the scene; and
for rendered pixels, based on the luminances of the pixels,
performing luminance correction based on the first luminance correction value, on pixels satisfying a condition under which it is determined that a pixel is dark, and
performing luminance correction based on the second luminance correction value, on pixels satisfying a condition under which it is determined that a pixel is bright.

16. The image processing method according to claim 15, further comprising:
rendering the virtual space based on lighting settings related to virtual time periods of day that transition according to the passage of time.

17. The image processing method according to claim 16, wherein
the first range is a range between a first correction minimum value and a first correction maximum value,
the second range is a range between a second correction minimum value and a second correction maximum value, and
the first correction minimum value, the first correction maximum value, the second correction minimum value, and the second correction maximum value are each set in association with each of the virtual time periods of day.

18. The image processing method according to claim 17, wherein
a determination minimum value and a determination maximum value related to the brightness of the scene are set in association with each of the virtual time periods of day, and
the method further comprises:
when the brightness of the scene is lower than or equal to the determination minimum value, determining that the first luminance correction value is the first correction maximum value, and the second luminance correction value is the second correction maximum value;
when the brightness of the scene is higher than or equal to the determination maximum value, determining that the first luminance correction value is the first correction minimum value, and the second luminance correction value is the second correction minimum value; and
when the brightness of the scene is between the determination minimum value and the determination maximum value, determining that the first luminance correction value is a value between the first correction minimum value and the first correction maximum value, and the second luminance correction value is a value between the second correction minimum value and the second correction maximum value, by interpolation based on the brightness.

19. The image processing method according to claim 17, further comprising:
setting the second correction maximum value to a value smaller than the first correction maximum value, in association with a first time period of day of the virtual time periods of day; and
setting the first correction minimum value and the second correction minimum value to the same value, and the first correction maximum value and the second correction maximum value to the same value, in association with a second time period of day of the virtual time periods of day.

20. The image processing method according to claim 16, wherein
the condition under which it is determined that a pixel is dark is that the luminance of the pixel is lower than a threshold set in association with the virtual time periods of day, and
the condition under which it is determined that a pixel is bright is that the luminance of the pixel is higher than or equal to the threshold.

21. The image processing method according to claim 15, wherein
the condition under which it is determined that a pixel is dark is that the luminance of the pixel is lower than a threshold, and
the condition under which it is determined that a pixel is bright is that the luminance of the pixel is higher than or equal to the threshold.

22. The image processing method according to claim 21, further comprising:
performing the luminance correction on a pixel whose luminance is lower than the threshold, by changing the luminance of the pixel by a first magnification factor depending on the first luminance correction value; and
performing the luminance correction on a pixel whose luminance is higher than or equal to the threshold, by changing the luminance of the pixel by a second magnification factor that further approaches from the first magnification factor to a magnification factor depending on the second luminance correction value as the luminance increases from the threshold.

23. The image processing method according to claim 15, further comprising:
obtaining the brightness of the rendered scene based on a light probe disposed in the virtual space.

24. The image processing method according to claim 23, further comprising:
obtaining the brightnesses of a plurality of sampling points set in the scene, based on the light probes arranged around positions in the virtual space related to the plurality of sampling points, and obtaining the brightness of the scene based on the brightnesses of the plurality of sampling points.

25. The image processing method according to claim 24, further comprising:
performing ray casting in a direction from a reference point in the virtual space, and setting the sampling point at, at least, a collision position of the ray casting with respect to an object in the virtual space, and one or more positions between the reference point and the collision position.

26. The image processing method according to claim 25, wherein
the reference point is set based on a position of a gaze point of a virtual camera.

27. The image processing method according to claim 26, further comprising:
performing the ray casting in one or more random directions for each rendering frame, and smoothing the brightness based on the sampling points due to the ray casting, and the brightness based on the sampling points due to the ray casting in a past frame, to obtain the brightness of the scene.

28. The image processing method according to claim 25, further comprising at least one of:
giving a greater weight to the sampling point closer to the reference point, and obtaining the total brightness of the plurality of sampling points as the brightness of the scene; and
setting more sampling points in regions closer to the reference point, between the reference point and the collision position caused by the ray casting.

29. An image processing system comprising:
one or more processors; and
one or more memories storing a program that when executed, causes the image processing system to perform operations including:
rendering a virtual space;
obtaining the brightness of a rendered scene;
determining a first luminance correction value in a first range and a second luminance correction value in a second range based on the brightness of the scene; and
for rendered pixels, based on the luminances of the pixels,
performing luminance correction based on the first luminance correction value, on pixels satisfying a condition under which it is determined that a pixel is dark, and
performing luminance correction based on the second luminance correction value, on pixels satisfying a condition under which it is determined that a pixel is bright.

30. The image processing system according to claim 29, wherein
the operations further include:
rendering the virtual space based on lighting settings related to virtual time periods of day that transition according to the passage of time.

31. The image processing system according to claim 30, wherein
the first range is a range between a first correction minimum value and a first correction maximum value,
the second range is a range between a second correction minimum value and a second correction maximum value, and
the first correction minimum value, the first correction maximum value, the second correction minimum value, and the second correction maximum value are each set in association with each of the virtual time periods of day.

32. The image processing system according to claim 31, wherein
a determination minimum value and a determination maximum value related to the brightness of the scene are set in association with each of the virtual time periods of day, and
the operations further include:
when the brightness of the scene is lower than or equal to the determination minimum value, determining that the first luminance correction value is the first correction maximum value, and the second luminance correction value is the second correction maximum value;
when the brightness of the scene is higher than or equal to the determination maximum value, determining that the first luminance correction value is the first correction minimum value, and the second luminance correction value is the second correction minimum value; and
when the brightness of the scene is between the determination minimum value and the determination maximum value, determining that the first luminance correction value is a value between the first correction minimum value and the first correction maximum value, and the second luminance correction value is a value between the second correction minimum value and the second correction maximum value, by interpolation based on the brightness.

33. The image processing system according to claim 31, wherein
the operations further include:
setting the second correction maximum value to a value smaller than the first correction maximum value, in association with a first time period of day of the virtual time periods of day; and
setting the first correction minimum value and the second correction minimum value to the same value, and the first correction maximum value and the second correction maximum value to the same value, in association with a second time period of day of the virtual time periods of day.

34. The image processing system according to claim 30, wherein
the condition under which it is determined that a pixel is dark is that the luminance of the pixel is lower than a threshold set in association with the virtual time periods of day, and
the condition under which it is determined that a pixel is bright is that the luminance of the pixel is higher than or equal to the threshold.

35. The image processing system according to claim 29, wherein
the condition under which it is determined that a pixel is dark is that the luminance of the pixel is lower than a threshold, and
the condition under which it is determined that a pixel is bright is that the luminance of the pixel is higher than or equal to the threshold.

36. The image processing system according to claim 35, wherein
the operations further include:
performing the luminance correction on a pixel whose luminance is lower than the threshold, by changing the luminance of the pixel by a first magnification factor depending on the first luminance correction value; and
performing the luminance correction on a pixel whose luminance is higher than or equal to the threshold, by changing the luminance of the pixel by a second magnification factor that further approaches from the first magnification factor to a magnification factor depending on the second luminance correction value as the luminance increases from the threshold.

37. The image processing system according to claim 29, wherein
the operations further include:
obtaining the brightness of the rendered scene based on a light probe disposed in the virtual space.

38. The image processing system according to claim 37, wherein
the operations further include:
obtaining the brightnesses of a plurality of sampling points set in the scene, based on the light probes arranged around positions in the virtual space related to the plurality of sampling points, and obtaining the brightness of the scene based on the brightnesses of the plurality of sampling points.
